(19) United States
(12) Patent Application Publication
(10) Pub. No.: US 2005/0255187 A1
(43) Pub. Date: Nov. 17, 2005

(54) METHODS AND DEVICES FOR MELT PRESSURE REGULATION

(75) Inventor: David O. Kazmer, North Andover, MA (US)

Correspondence Address: NUTTER MCCLENNEN & FISH LLP, WORLD TRADE CENTER WEST, 155 SEAPORT BOULEVARD, BOSTON, MA, 02210-2604, US

(73) Assignee: UNIVERSITY OF MASSACHUSETTS, Worcester, MA (US)

(21) Appl. No.: 10/908,000

(22) Filed: Apr. 25, 2005

Related U.S. Application Data
(60) Provisional application No. 60/571,103, filed on May 14, 2004.

(51) Int. Cl. B29C 45/23

(52) U.S. Cl. 425/563

(57) ABSTRACT

Methods and devices are provided for controlling melt pressure in an apparatus that processes molten material. In one exemplary embodiment, the methods and devices utilize a self-regulating valve that is effective to regulate a melt pressure through a melt flow channel. In particular, the valve can be adapted to maintain an equilibrium between a control force applied to a control member and a dynamic force applied to the control member by the melt pressure of a melt flowing through a melt flow channel.

### CROSS REFERENCE TO RELATED APPLICATIONS

This application claims priority to U.S. Provisional Application No. 60/571,103, filed on May 14, 2004 and entitled “Methods and Devices for Pressure Regulation in a Melt Flow Apparatus,” which is hereby incorporated by reference in its entirety.

### FIELD OF THE INVENTION

The present invention relates to methods and devices for use with apparatus for processing molten materials, and in particular to a self-regulating valve for regulating the melt pressure of a melt at the outlet of the valve.

### BACKGROUND OF THE INVENTION

Apparatus for processing molten materials, such as injection molding, extrusion, and blow molding apparatus, are highly efficient techniques for plasticizing and pressurizing a melt for subsequent forming through a mold or die. Such processes, however, are governed by the flow of a heated melt into a mold or die, and thus the quality of the molded products is related to the pressure of the melt. In conventional feed systems, the volumetric flow rate and pressure of the melt is determined by the design of the feed system. Once machined, conventional feed systems are unable to significantly change the behavior of flow entering a die or cavity at one location without similarly affecting the flow of plastic at other locations or retooling the feed system. As such, these forming processes may not achieve the desired quality or economic performance in a given application.

Several techniques have therefore been developed to regulate the melt pressure. Such techniques include, for example, the use of dynamically actuated pins to modify the flow resistance in a feedback control loop that compares the observed downstream pressure to the desired downstream pressure. Alternatively, the use of gear pumps rotating at a constant speed has been used to supply melt pressure at a desired level. Both of these solutions are limited in their performance and cost. Specifically, these systems are relatively large and require costly control systems. Furthermore, the reaction time of these systems is limited by their design.

Accordingly, there remains a need for improved methods and devices for controlling the pressure of a melt in an apparatus for processing molten materials that does not require pressure transducers, control systems, or large actuation forces.

### BRIEF SUMMARY OF THE INVENTION

The present invention provides methods and devices for controlling the pressure of a melt in an apparatus for processing molten materials. In one exemplary embodiment, a self-regulating valve is provided and it is effective to receive a dynamic force that is proportional to a pressure of a melt flowing through a flow channel in a body, and to move in response to changes in the dynamic force applied thereto so as to regulate a melt pressure of the melt at the outlet of the flow channel. In use, by way of non-limiting example, the self-regulating valve can be part of a machine nozzle, an injection mold, or an extrusion die.

While the valve can have a variety of configurations, in one embodiment the valve includes a body having an inlet and an outlet with a flow channel extending therebetween for receiving a melt therethrough, and a valve pin having a distal end that is adapted to communicate with the flow channel to control the melt therethrough. The distal end can be adapted to receive a proximally-directed dynamic force that is proportional to a pressure of the melt at the outlet of the flow channel, and the valve pin can be adapted to receive a distally-directed control force that is effective to move the valve pin in response to changes in the dynamic force thereby regulating a melt pressure if the melt through the channel. In one exemplary embodiment, the proximally-directed dynamic force can be adapted to move the valve pin toward a closed proximal position, in which melt flowing through the outlet of the flow channel is substantially prevented, and the distally-directed control force can be adapted to move the valve pin toward an open distal position, in which melt flowing through the outlet is allowed.

A variety of techniques can be used to provide a control force to the valve pin, however in one exemplary embodiment the valve pin is coupled to an actuator for applying a control force to the valve pin to move the valve pin in response to imbalances between the control and dynamic forces. The actuator can be adapted to move the valve pin toward an open position, in which the valve pin allows melt flow through the flow channel, in response to an undesired decrease in the dynamic force. The actuator can also be adapted to move the valve pin toward a closed position, in which the valve pin substantially limits the melt flowing through the channel to avoid an undesired increase in the dynamic force. In certain exemplary embodiments, the control force applied by the actuator can be adapted to be adjusted as a function of time. In other embodiments, the control force applied by the actuator can be adapted to be adjusted in response to a melt pressure sensed at a location remote to the valve pin. Exemplary actuators include, for example, hydraulic cylinders, pneumatic actuators, pre-loaded springs, solenoids, and electric motors. The actuator can be adjustable to allow adjustment of the control force applied by the actuator to the valve pin.

The configuration of the valve pin can also vary, but in one exemplary embodiment the valve pin can have an aperture formed therein and in communication with the inlet in the flow channel of the body, and a distal head positioned distal of the aperture and adapted to control melt pressure at the outlet. In one exemplary embodiment, the valve pin can have a cylindrical shape with an outer diameter that is about 5 mm, and the aperture can be in the form of an annular grove or annulus having a diameter about one-half the outer diameter. One skilled in the art will appreciate that the size of the valve can be modified to accommodate varying applications.

In other aspects, an apparatus is provided for controlling melt pressure, and it includes a body having an inlet and an outlet with a flow channel extending therebetween, a control member movably coupled to the body and adapted to receive a dynamic force proportional to a melt pressure of a melt at the outlet of the flow channel, and an actuator adapted to apply a control force to the control member in response to the dynamic force. In use, differentials between the control force and the dynamic force can cause movement of the control member until the control force and the dynamic force equilibrate, thereby regulating the melt pressure at the outlet of the flow channel. In one exemplary embodiment, the control member can be movable between an open position, in which a melt can flow through the outlet, and a closed position, in which the melt is substantially prevented from flowing through the outlet. The control member can be adapted to move toward the open position in response to an increase in the dynamic force, and the control member can be adapted to move toward the closed position in response to a decrease in the dynamic force.

The control member can have a variety of configurations, for example it can be in the form of a pin member having a proximal portion that is coupled to the actuator and a distal portion that is positioned adjacent to the outlet. The distal portion can include a reduced diameter region disposed within the flow channel to allow a melt to flow through the flow channel in the body, and a head distally adjacent to the reduced diameter region that is configured to regulate melt pressure at the outlet of the flow channel.

Exemplary methods are also provided for controlling a melt pressure of a melt at an outlet port of a melt flow apparatus having an inlet and an outlet port. In one embodiment, the method includes positioning a portion of a self-regulating control member within a melt flow channel such that the control member receives a dynamic force proportional to a melt pressure at the outlet of the flow channel, and applying a control force to the control member in response to deviations in the dynamic force to regulate a melt pressure at the outlet. The control member can be movable between an open position, in which a melt can flow through the outlet of the flow channel, and a closed position, in which the melt is substantially prevented from flowing through the outlet of the flow channel. The dynamic force applied to the control member can move to the control member toward the closed position, and the control force applied to the control member can move the control member toward an open position.

### BRIEF DESCRIPTION OF THE DRAWINGS

FIG. 1 is a partially cross-sectional view of one exemplary embodiment of a self-regulating valve for use with an apparatus for processing molten materials;

FIG. 2 is a partially cross-sectional view of another embodiment of a self-regulating valve for use with an apparatus for processing molten materials;

FIG. 3 is a cross-sectional view illustration of yet another embodiment of a self-regulating valve for use with an apparatus for processing molten materials;

FIG. 4 is a schematic diagram illustrating a machine nozzle having a self-regulating valve coupled to a pneumatic actuator in accordance with another exemplary embodiment;

FIG. 5 is a schematic diagram illustrating an injection hot runner mold having two self-regulating valves disposed therein and coupled to hydraulic actuators in accordance with another exemplary embodiment; and

FIG. 6A is a cross-sectional schematic diagram illustrating a sheet extrusion die having two self-regulating valves (only one valve is shown) disposed therein and coupled to an electric actuator;

FIG. 6B is a cross-sectional schematic diagram of the sheet extrusion die shown in FIG. 6A taken across line B-B;

FIG. 7A is a diagram illustrating one exemplary embodiment of a user interface;

FIG. 7B is a diagram illustrating another exemplary embodiment of a user interface; and

FIG. 8 is a chart showing the melt pressure at a valve outlet observed as a function o the air pressure provided to a corresponding pneumatic actuator.

### DETAILED DESCRIPTION OF THE INVENTION

The present invention provides methods and devices for controlling a melt pressure of a melt in an apparatus that processes molten material. In one exemplary embodiment, a self-regulating valve is provided and it has a control member that is effective to receive a dynamic force that is equivalent to a melt pressure of a melt at the outlet, and that is effective to generate a control force for counteracting any changes that occur in the dynamic force. As a result, an equilibrium can be created between the control force and the dynamic force to maintain regulate a melt pressure. The self-regulating valve can be used in virtually any apparatus for processing molten material, hereinafter “melt flow apparatus.” Exemplary apparatus include, by way of non-limiting example, a polymer processing apparatus (e.g., extruder, injection molder, blow molder, or other net shape plastics manufacturing apparatus), or similar metal casting apparatus for manufacturing of net shape products.

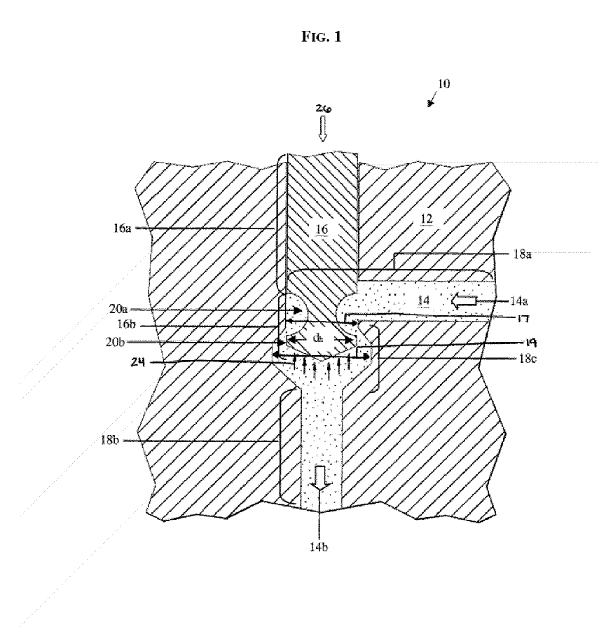

FIG. 1 illustrates one exemplary embodiment of self-regulating valve 10 for controlling a melt pressure of a melt in a melt flow apparatus. In general, the valve 10 includes a body 12 with a flow channel 14 extending therethrough between an inlet 14a and an outlet 14b, and a self-regulating control member 16 that is movable relative to the body 12 and that has a portion that extends into the channel 14 to regulate a melt flowing therethrough.

The body 12 can have a variety of configurations, shapes, and sizes depending on the intended use. In the illustrated embodiment, the body 12 is in the form of a housing that is configured to be removably or fixedly disposed within a melt flow apparatus. As indicated above, the body 12 includes a flow channel 14 extending therethrough and having an inlet 14a and an outlet 14b. The inlet 14a is configured to couple to the outlet of a melt flow apparatus such that a melt, e.g., a molten polymer or molten metal, flows from the apparatus into the inlet 14a, through the channel 14, and out the outlet 14b which can be coupled to a variety of devices including, for example, a die, cavity, mandrel, cast, etc. The particular shape or path of the melt flow channel 14 can vary depending on the intended use.

In the embodiment shown in FIG. 1, the flow channel 14 is substantially L-shaped. In particular, the inlet 14a extends in a direction that is substantially transverse to a direction of the outlet 14b, and the outlet 14b is in-line or coaxial with the valve pin 16. In other words, the flow channel 14 includes a first pathway 18a that forms the inlet 14a and a second pathway 18b that forms the outlet 14b and that is transverse to the first pathway 18a. The flow channel 14 also includes a middle region or pathway 18c that is positioned between and connects the first and second pathways 18a, 18b. The middle pathway 18c essentially forms part of the second pathway 18b, however it has an enlarged diameter for receiving the control member 16, which will be discussed in more detail below.

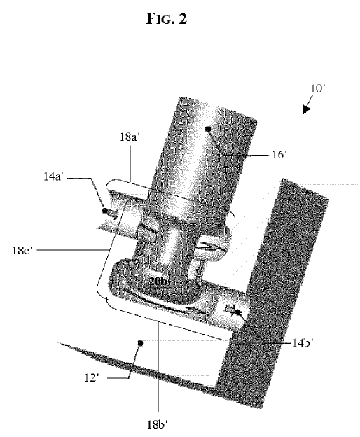

FIG. 2 illustrates another embodiment of a valve 110′ that is similar to valve 10 shown in FIG. 1, however the flow channel 14′ in the body 12′ is substantially S- or Z-shaped to allow the inlet 14a′ and the outlet 14b′ to extend in the same direction, which is substantially transverse to the valve pin 16′. In particular, the flow channel 14′ includes a first pathway 18a′ that forms the inlet 14a′, a second pathway 18b′ that forms the outlet 14b′, and a middle pathway 18c′ that extends transverse to and between the first and second pathways 18a′, 18b′. As with the middle pathway 18c shown in FIG. 1, the middle pathway 18c′ in the embodiment shown in FIG. 2 is configured to receive the control member 16′.

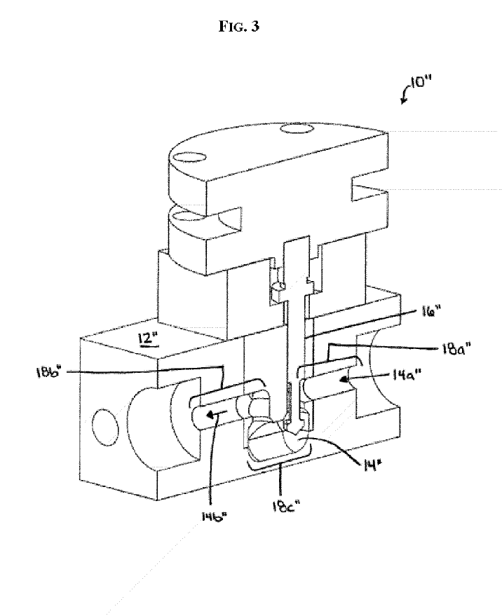

FIG. 3 illustrates another embodiment of a valve 10″ having a body 12″ with a flow channel 14″. In this embodiment, the flow channel 14″ is substantially U-shaped, and it includes a first pathway 18a″ that forms the inlet 14a″, a second pathway 18b″ that forms the outlet 14b″, and a middle pathway 18c″ that connects the first and second pathways 18a″, 18b″ and that is adapted to receive the control member 16″. The first and second pathways 18a″, 18b″ are in-line with one another and each pathway 18a″, 18b″ extends in a direction that is substantially transverse to a direction of the control member 16″. The middle pathway 18c″ is U-shaped with terminal ends that connect to the first and second pathways 18a″, 18b″. The control member 16″ is adapted to extend into one leg of the U-shaped middle pathway 18c″, as will be discussed in more detail below.

A person having ordinary skill in the art will appreciate that the configuration of the valve body 12, 12′, 12″, as well as the shape and configuration of the flow channel 14, 14′, 14″ can vary depending on the intended use. For manufacturing, assembly, and maintenance reasons it may be desirable to assemble the body from more than one component that can be readily manufactured, assembled, and disassembled.

Referring back to FIG. 1, the valve 10 also includes a control member 16 that is effective to control the flow of a melt through the flow channel 14. The control member 16 can have a variety of configurations, however in one exemplary embodiment, as shown, the control member 16 is in the form of a substantially cylindrical valve pin having a proximal portion 16a and a distal portion 16b. The proximal portion 16a is adapted to couple to an actuating member 22, which will be discussed in more detail below, and thus the configuration of the proximal portion 16a can vary depending on the configuration of the actuating member 22. The distal portion 16b of the control member 16 can also vary in shape and size depending on the shape and size of the middle pathway 18c formed in the body 12, however the distal portion 16b of the control member 16 should be effective to control the flow of a melt through the flow channel 14 in the body 12. In an exemplary embodiment, as shown, the distal portion 16b includes a reduced diameter region or annular aperture 20a that is formed just proximal to a distal-most end, and a head 20b that is positioned distally adjacent to the aperture 20a. The aperture 20a can have a variety of shapes and sizes, but it is preferably adapted to communicate a melt flowing between the inlet 14a and outlet 14b, and more particularly between the first pathway 18a and the second pathway 18b. The head 20b can also have a variety of shapes and sizes, but it is preferably configured to allow a melt to flow therearound when the head 20b is in an open position, i.e., when the head 20b is moved distally and positioned within the middle pathway 18c. The head 20b is also preferably configured to prevent melt flowing through the channel 14 when the head 20b is in a closed position, i.e., when the head 20b is moved proximally to block melt flowing between the first and second pathways 18a, 18b. In the illustrated embodiment, the head 20b has an outer diameter dh that is smaller than a diameter of a central portion 19 of the middle pathway 18c, and that is sized to abut against or closely fit within a proximal opening 17 of the middle pathway 18c. Thus, in use, movement of the head 20b toward the fully open position, i.e., toward the central portion 19 of the middle pathway 18c, will increase melt flowing through the pathway 18c, and movement of the head 20b toward the closed position, i.e., toward the proximal opening 17 of the middle pathway 18c, will decrease melt flowing through the pathway 18c.

The head 20b is also preferably adapted to receive a dynamic force from a melt flowing through the channel 14, as will be discussed in more detail below. The shape of the head 20b can thus be streamlined to facilitate proper translation of the dynamic force from the melt to the control member 16. As shown in FIG. 1, the head 20b has a distal-most surface that is tapered to form a cone-shape. The cone-shaped configuration allows the melt to act thereon as it moves from the inlet 14a to the outlet 14b. While the geometry of the distal-most end is not of critical significance, it is preferably designed to avoid excessive pressure drops and shear stresses that may induce significant error in the melt pressure at the valve outlet 14b. FIG. 2 illustrates another embodiment of a control member 16′ having a head 20b′ that is not cone-shaped, but rather that has a substantially planar distal-most surface with rounded edges. The shape of the middle pathway 18c′ will facilitate the flow of a melt around the head 20b′ to allow the planar distal-most surface to receive the dynamic force from the melt.

A person skilled in the art will appreciate that the control member 16 can have a variety of other configurations and it does not have to be symmetric about the axis, as shown in the accompanying drawings. Many other designs are also feasible. For example, the control member 16 may utilize an annulus that has a rectangular section with rounded corners or an annulus with an elliptical annulus that is shaped like a rain drop. It is also possible to utilize a control member 16 that is non-symmetrical about the axis to control the flow around and along the pin.

As indicated above, in use the control member 16 is configured such that a melt pressure of a melt flowing through the channel 14 will act on the head 20b of the control member 16 to generate a force 24, referred to herein as a dynamic force 24. This force is substantially proportional to a melt pressure of the melt. While the application of the force to the head 20b will vary depending on the shape of the head 20b, in the embodiment shown in FIG. 1 the force 24 is applied in a proximal direction, as indicated by the arrows. The dynamic force 24 can thus cause the control member 16 to move toward the closed position, in which melt flowing through the channel 14 is decreased. The control member 16 can also be configured to receive a control force 26 that is applied thereto and that is effective to move the control member 16 toward the fully open position, in which melt flowing through the channel 14, 14′, 14″ is increased. The direction of the control force 26, as indicated in FIG. 1, is opposite to the direction of the dynamic force 24. Accordingly, together the dynamic force 24 and the control force 26 act on the control member 16 to form an equilibrium therebetween. Thus, if any changes occur in the melt pressure, and consequently the dynamic force 24, the control force 26 will counteract the changes in the dynamic force 24. The control member 16 is therefore self-regulating as it will be continually and automatically moved until the control force 26 and the dynamic force 24 are equal to regulate the melt pressure.

As explained in more detail with reference to FIG. 1, a melt flowing through the flow channel 14 will flow into the aperture 20b and around the head 20a to apply a dynamic force 24 against the distal-most surface of the head 20a. As a result, the control member 16 can be moved proximally toward the closed position to decrease melt flowing from the middle pathway 18c to the second pathway 18b, thereby decreasing the melt pressure at the outlet 14b of the body 12. Conversely, the control force 26 will move the control member 16 in a distal direction toward the fully open position to increase melt flowing from the middle pathway 18c to the second pathway 18b, thereby increasing the melt pressure at the outlet 14b of the body 12. This will continue until an equilibrium is established between the dynamic force 24 and the control force 26, thereby obtaining a desired melt pressure. In other words, differentials in the control force 26 and the dynamic force 24 cause movement of the control member 16 until the control force and the dynamic force equilibrate, thereby regulating the melt pressure through the flow channel 14 in the body 12.

A person skilled in the art will appreciate that certain variables present within the system need to be considered and adjusted as necessary in order to regulate the melt pressure at the outlet 14b of the device 10. For example, because melts are viscous in nature, there will be shear stresses which would tend to pull the control member 16 in the direction of flow, as well as a related pressure differential that would tend to push the control member 16 opposite to the direction of flow. Since these forces counteract and are small compared to the control force 26, it is possible to design the control member 16 such that the forces resulting from melt flowing through the valve 10 do not induce significant error in the outlet pressure. One skilled in the art is familiar with viscous flow in such valve geometries and may analyze the shear stresses and pressure drop through the valve using flow equations or numerical simulations. By comparing the forces due to the pressures and shear stresses acting on the control member 16, the control member 16 may be designed to minimize the sensitivity to fluctuations in viscosity and flow rate.

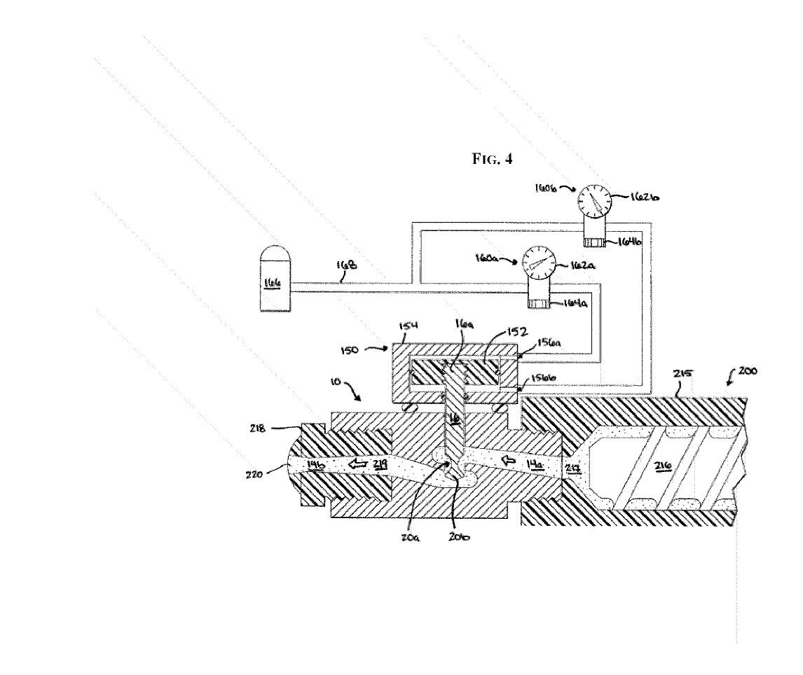

The control force 26 can be generated using a variety of techniques, however in one exemplary embodiment the proximal portion 16a of the control member 16 is coupled to an actuating member, certain exemplary embodiments of which will be described in more detail with respect to FIGS. 4-6B. By way of non-limiting example suitable actuating members include a hydraulic cylinder, a pneumatic actuator, a spring that is pre-loaded to correspond to the melt pressure at the outlet, an electric motor, a solenoid, or any other device that is effective to apply a force to the control member. The particular actuator used can be selected based on the configuration of the valve and the intended use.

In use, the actuating member is preferably adapted to apply a control force 26 at an amount that is effective to counteract any changes in the dynamic force 24 and to establish an equilibrium. An intensification ratio may be utilized to relate the control force 26 to the melt pressure at the outlet 14b. For example, a valve 10 having a control member 16 with a head 20b having a diameter dh of 5 mm may be utilized with a pneumatic cylinder having a diameter of 50 mm and a pneumatic supply valve that provides 0-1 MPa pneumatic pressure corresponding to a 0 to 10 V control signal. For this case, a 10 V control signal would correspond to a 100 MPa pressure at the valve outlet 14b; other intermediate voltages between 0 and 10 V would proportionally provide between 0 and 100 MPa pressure at the valve outlet 14b. The valve body 12, control member 16, and actuator can thus be design to achieve the desired range of pressures at the valve outlet 14b.

As indicated above, FIGS. 4-6B illustrate various exemplary embodiments of actuating members, as well as use of the valve 10 in various melt flow apparatus. A person skilled in the art will appreciate that while valve 10 of FIG. 1 is shown in FIGS. 4-6B, that the valve 10 can have a variety of other configurations.

Referring first to FIG. 4, the valve 10 is used to limit the melt pressure supplied to an injection mold from the injection unit of a plastics molding machine. In particular, the valve 10 is disposed within a machine nozzle 200, and the proximal end 16a of the valve 10 is coupled to a pneumatic actuator 150 that is used to deliver a control force to the control member 16 of the valve 100.

In the illustrated exemplary embodiment, the machine nozzle 200 generally includes a barrel 215 having a screw 216 that is used to plasticate and force a melt through an outlet 217 of the barrel 215, into the inlet 14a of the valve 10, through the outlet 14b of the valve 10, to the inlet 219 of a nozzle tip 218, and then from an orifice 220 in the nozzle tip 218 to an injection mold. As previously described with respect to FIG. 1, the aperture 20a on the control member 16 of the valve 10 communicates the melt from the inlet 14a to the outlet 14b. As the melt flows around the head 20b of the control member 16, the melt pressure of the melt applies a dynamic force to the control member 16 to force the control member 16 toward a closed position, i.e., proximally toward the pneumatic actuator 150. The actuator 150, which is coupled to the proximal end 16a of the control member 16, has a piston 152 residing in a housing 154 that receives compressed air via a push port 156a and a pull port 156b. The air pressure can be regulated by pressure regulators 160a, 160b that are respectively controlled by knobs 164a, 164b with feedback of air pressure provided through gages 162a, 162b. The supplied air pressure is from a compressor with an accumulator 166 through pneumatic lines 168. Depending on the pressure supplied to the actuator 150, a control force is provided to the control member 16 so that the melt pressure at the valve outlet 14b is regulated. In many applications, only the pressure regulator 160a supplying air pressure to the push port 156a is required to provide a compressive control force to the control member 16. However, it may sometimes be desirable to design the control member 16 and actuator 150 to provide a tensile control force to the control member 16, so as to retract the control member 16 to a closed position, thereby sealing the melt at the inlet 14a from the outlet 14b. Such closure may be accomplished by increasing the magnitude of the pressure at the pull port 156b above the magnitude of the pressure at the push port 156a. Alternatively, a single acting cylinder may be utilized in which an internal spring will tend to retract the control member 16 and only provide a compressive control force when the inlet pressure at the push port 156a exceeds a known threshold.

The valve 10 can also be used in a variety of other melt flow apparatus. For example, a self-regulating valve may be provided at the inlet of a runner system or sprue of an injection mold to limit the melt pressure supplied to an injection mold from the injection unit of a plastics molding machine. In other embodiments, the pressure from an extruder may be regulated by placing a self-regulating valve in a plate between an extruder and a die. One skilled in the art would understand that the valve may also be used in many other processing applications.

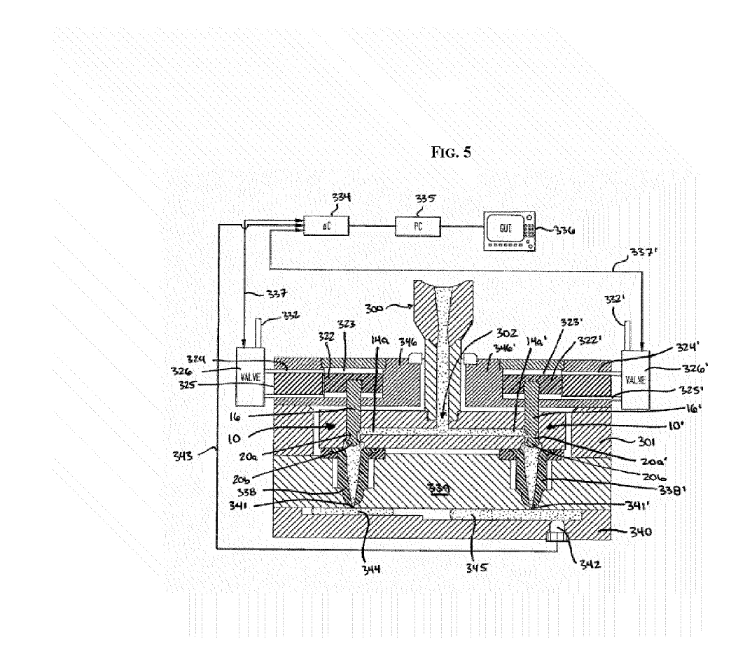

FIG. 5 illustrates another use of a self-regulating valve to control the melt pressure supplied to one or more locations in a hot runner manifold 301. In this embodiment, two valves 10, 110′ are shown, however the apparatus can use any number of valves 10, 110′. As shown, a melt is provided from a nozzle tip 300 of an injection molding machine to the inlet 302 of the hot runner manifold 301. The melt is communicated from the inlet 14a, 14a′ of each valve 10, 110′, through the aperture 20a, 20a′ and around the head 20b, 20b′ of each control member 16, 16′, to the outlet 14b, 14b′ of each valve 10, 110′. After the melt travels through the valves 10, 10′, the melt travels to a gate 341, 341′ through a nozzle 338, 338′ and into a mold cavity that is formed between a mold plate 339 and a mold plate 340. Depending on the geometry of the mold cavity, material properties, and melt pressures as regulated by one or more self-regulating valves 10, 110′, the melt pressure to different regions 344 and 345 of the mold can be individually controlled.

In the illustrated embodiment, the control force used to regulate the melt pressure through each valve 10, 10′ is provided by a piston 322, 322′ that travels within a housing 323, 323′ of a mold plate 346, 346′. Hydraulic pressure is provided via a push port 324, 324′ and a pull port 325, 325′ that acts on each piston 322, 322′. A pressure control valve 326, 326′ communicates hydraulic fluid at controlled pressures to the push and pull ports 324, 324′, 325, 325′ in response to a control signal provided by an electrical cable 337, 337′. A person skilled in the art will appreciate that many other types of hydraulic valves may be used. Typically, the hydraulic fluid is supplied via a hose 332, 332′ from a hydraulic pump and accumulator. With respect to the selection of the hydraulic valve, a proportional control valve may be utilized to provide hydraulic fluid to the push ports 324, 324′ at a pressure that is proportional to the control signal. As an alternative, a servo-valve may be utilized to provide hydraulic fluid to the push ports 324, 324′ at a pressure that is proportional to the control signal and in response to the measured hydraulic output pressure. When available, feedback signals relating to the measured hydraulic pressure may be fed back to one or more microcontrollers through an appropriate multi-conductor cable 337, 337′. In the embodiment shown in FIG. 5, a microcontroller 334 is connected to a computer 335 which utilizes an operator station 336 with a graphical user interface to communicate process information to an operator and receive command information from an operator. The microcontroller 334 may receive feedback information regarding the hydraulic pressure from one or more valves 10, 110′, as well as melt pressure via a cable 343 connected to one or more melt pressure transducers 342. The information may be used to communicate the state of the plastics molding process to an operator, or to otherwise generate control signals in real time response. One skilled in the art will appreciate that there are many different types of control systems that may be used. For example, it is possible to design a control system with no pressure feedback or computer that provides real-time pressure profiling using one or more self-regulating valves. As an alternative, a control system may be designed that uses melt pressure feedback from one or more melt pressure transducers with a computer and one or more self-regulating valves to control the melt pressure in the cavity, and provide feedback regarding the process to the mold operator via pressure graphs and control charts.

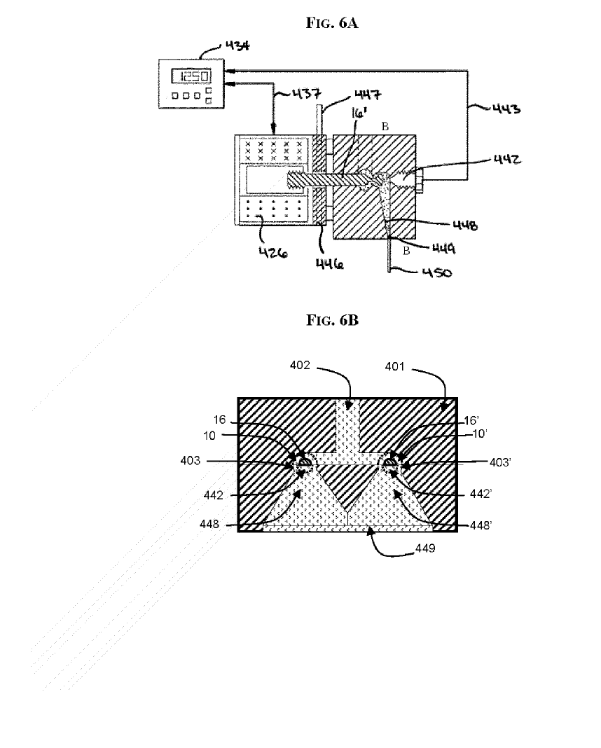

FIGS. 6A and 6B illustrate another exemplary use of a self-regulating valve in a sheet extrusion die. As shown, a melt is received from an extruder at the inlet 402 of a die 401 that houses two valves 10, 10′ having two control members 16, 16′. The control members 16, 16′ communicate the melt from the inlet 401 to outlets 403, 403′, and the melt then travels through the die cavity 448 to a lip 449 where an extrudate 450 is formed. By using one or more self-regulating valves 10, 110′, the melt to one or more areas of the extrusion die may be independently controlled.

In the embodiment shown in FIGS. 6A and 6B, the control force is produced by an electric solenoid 426, shown in FIG. 6A coupled to valve 110′. A cooling plate 446 can be provided between the die 401 and the actuator 426 to cool the control member 16′. Coolant can be circulated into the cooling plate 446 via one or more hoses 447 coupled thereto. In use, the solenoid 426 receives a control signal via a cable 437 from a controller 434 that includes a display for communicating processing information to an operator, and buttons and/or keys for receiving command information from the operator. Depending on the configuration of the solenoid 426 and control system 434, process feedback regarding the temperature of the solenoid 426 and the applied load may be provided back to the controller 434. The controller may also receive melt pressure information from one or more melt pressure transducers 442 via one or more cables 443. The information may be used to communicate the state of the plastics molding process to an operator, or to otherwise generate control signals in real time response.

While the self-regulating valve does not require a controller to receive any information regarding the melt pressure or control forces, it is possible to utilize such information to control the melt pressure at locations remote to the valve itself. For example, one or more melt pressure transducers may be placed in a mold cavity to measure the melt pressure at one or more locations downstream of one or more self-regulating valves. As another example, one or more thickness gages may be utilized to measure the thickness of one or more extrudates downstream of one or more self-regulating valves. If such information is available, then a closed loop control system may be utilized to adjust the control force and the outlet melt pressure from one or more self-regulating valves to control the measured downstream state. A portion of a control algorithm is shown in Table 1 below for providing control signals to one or more actuators that provide control forces to one or more corresponding control member according to both open and closed loop control algorithms.

TABLE 1

| | |
|---|---|
| 1: | If iControlType(i) = 1 Then |

| | |
|---|---|
| 2: | ′ Open Loop Control |
| 3: | sVout (iIter, i) = GetProfilePoint(i) * 10.0 / 100.0 |

| | |
|---|---|
| 4: | Else If iControlType(i) = 2 Then |

| | |
|---|---|
| 5: | ′ Closed Loop Control |
| 6: | dProfilePressures(iIter, i) = GetProfilePoint(i) |
| 7: | dErrPropP(i) = dProfiledPressures(iIter, i) − |

dObservedPressures (iIter, i)

| | |
|---|---|
| 8: | dErrIntP(i) = dErrIntP(i) + dErrPropP(i) * dt |
| 9: | If iIter > 0 Then |

| | |
|---|---|
| 10: | dErrDerP(i) = ((dProfiledPressures(iIter, i) − |

```
  dObservedPressures(iIter, i)) −
(dProfiledPressures(iIter − 1, i) −
  dObservedPressures(iIter − 1, i))) / dt
```

| | |
|---|---|
| 11: | Else |

| | |
|---|---|
| 12: | dErrDerP(i) = 0 |

| | |
|---|---|
| 13: | End If |
| 14: | sVout(iIter, i) = dkP * dErrPropP(i) + dkI * dErrIntP(i) + |

dkD * dErrDerP(i)

| | |
|---|---|
| 15: | End If |
| 16: | If sVout(iIter, i) < 0 Then sVout(iIter, i) = 0 |
| 17: | If sVout(iIter, i) > 10 Then sVout(iIter, i) = 10 |

Each time step ilter occurs, the control of valve i is considered. If the control type is open loop as specified by iControlType(i) equal to one, then the output voltage sVout at the time step ilter for valve i is set directly to whatever control profile has been specified by the user. The described design and open loop control algorithm was found to provide a stable and rapid response for all process conditions and materials investigated. If the control type is closed loop as specified by iControlType(i) equal to two, then the desired pressure is obtained from the specified profile and placed in dProfilePressures(ilter, i). The proportional error for valve i, dErrPropP(i), is obtained by subtracting the desired pressure from the observed pressure at line 7. The integral error, dErrlntP(i), is then updated at line 8 and the derivative error, dErrDerP(i), is updated at lines 9-13. The output voltage is then calculated by multiplying the proportional, integral, and derivative errors with the proportional, integral, and derivative gains (respectively dkP, dkl, and dkD). Finally, the output voltage is restricted to the limits of 0 to 10 to correspond to the allowable range of input voltages for the actuators. For a design in which the pressure is in the range of 0 to 100 MPa, the control signal is in the range of 0 to 10 V, and the time step dt was 0.005 seconds, the closed loop controller was found to provide a desirable response for a proportional gain between 0.6 and 0.8, an integral gain between 0 and 1, and a derivative gain between 0 and 0.02.

One skilled in the art would appreciate the simplicity of the open loop control, as well as the potential trade-offs associated with closed loop control. In general, closed loop control may provide compensation to external variation, but at the cost of additional transducers, cabling, and controller complexity. As such, an instrumentation strategy and control system design can be configured to provide the desired performance based on the intended application.

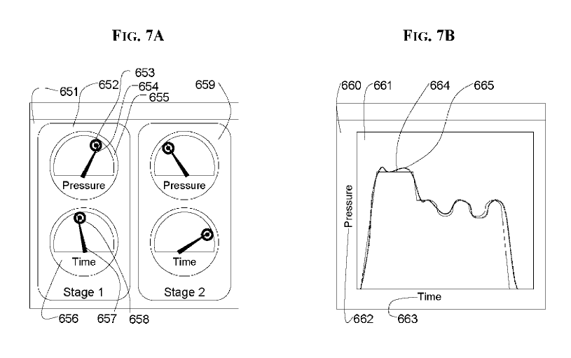

As previously indicated with respect to FIGS. 4-6B, the apparatus may include a user interface for providing feed back to a user. The configuration of the user interface may vary from a simple pressure regulator with a knob and gage, to a controller with a display and buttons or keys, to a general purpose computer with a graphical user interface, keyboard, and mouse. FIGS. 7A and 7B illustrate two exemplary embodiments of user interfaces.

FIG. 7A illustrates one exemplary embodiment of a screen 651 that provides an interface for setup and monitoring two pressure stages 652, 659. Each stage 652, 659 has a time gage 656 and a pressure gage 655 in which the time target 658 and pressure target 653 may be set by the operator. If desired, the pressure indicator 657 and time indicator 654 may be plotted on the same gage. The two stages 652, 659 can have various meanings relative to the manufacturing process being controlled. For example, the two stages 652, 659 might be used to control a self-regulating valve during the filling and packing stages of injection molding. As another example, the two stages 652, 659 might be used to dither the melt pressure at one or more self-regulating valves and thereby facilitate mixing of a melt front at a downstream location in a sheet extrusion process.

FIG. 7B illustrates another exemplary embodiment of a screen 660 that provides an interface for setup and monitoring melt pressure for a self regulating valve. As shown, a graph 661 plots the pressure 662 as a function of the time 663. The operator may specify a desired pressure profile 664 by dragging points on the screen, entering data in a table, specifying parameters for a function generator, or through a variety of other means. If desired, the controller can then plot the trace 665 for pressure sensed by a pressure transducer or other measured process state as a function of time.

While not required, the controller can optionally utilize other forms of sensed process information and perform various functions other than those explicitly described herein. For example, in some applications it may be useful to monitor the temperature and pressure of the melt at the inlet of a nozzle, hot runner manifold, an extrusion die, and at other locations. This information may be used by the controller to assess the consistency of the manufacturing process, to diagnose faults in the manufacturing process, to assist the operator in obtaining a desirable process, and to accomplish other process feats.

A person skilled in the art will appreciate that the valve can have a variety of other configurations, and that it can be used with either open or closed loop control system designs. The valve can also be used, for example, to fine-tune and automatically regulate a melt supply to multiple dies from a single extruder, to limit the pressure at the inlet of an injection mold, and to achieve closed loop control of melt pressure at multiple points in an injection mold.

While not a requirement of the design, it is also possible to use process instrumentation such as melt pressure or temperature transducers to provide feedback of the manufacturing process to a process or quality controller. Such feedback may be useful for a quality controller to identify fluctuations in the pressure and/or temperature of the melt being provided to the inlet of the self-regulating valve. As another example, such feedback may be useful by a process controller to identify improper processing conditions (such as inadequate supply pressure to the inlet) and subsequently suggest corrective action to the process operators. In other embodiments, process feedback may be used by a process controller to directly control the melt pressure at locations downstream of the valve by providing closed loop control signals to adjust the control force to the valve pin.

The following non-limiting examples serve to further describe certain exemplary embodiments of the invention.

### EXAMPLE 1

A control member, i.e., a valve pin, was machined from steel with an outer diameter of 5 mm and an inner annulus or aperture having a diameter of 2.5 mm. With 3 mm travel, the valve was found to provide excellent performance and longevity in an injection molding process for flow rates of 20 cc/sec and pressures of 100 MPa. Flow analysis and experimental validation has shown that this design is suitable for a wide range of materials and processing conditions. Flow analysis was performed with commercially available flow simulations and indicates that much higher rates of flow may be accommodated with a small increase in the size of the aperture.

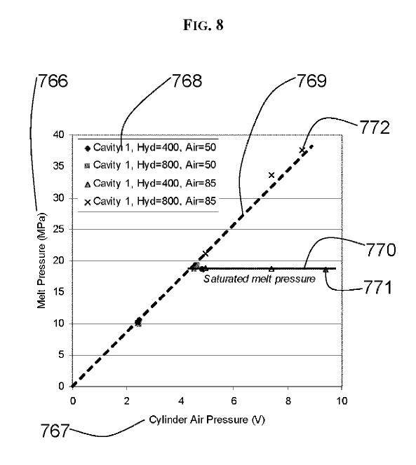

The performance of the self-regulating is shown in FIG. 8, which plots the observed melt pressure 766 in an injection mold cavity as a function of the observed air pressure 767 in a pneumatic actuator providing a control force to a self-regulating valve. As indicated by the data points lying near the line of proportionality 769, the valve provided melt pressure control without melt pressure transducers in proportion to the control force. The small variations from this line are due to pressure drops occurring between the outlet of the valve and the location of the pressure transducer in the mold cavity. One skilled in the art should also understand the cause of the plateau 770 in the observed melt pressure at approximately 19 MPa. Specifically, the three triangles 771 correspond to a molding process in which high air pressures and low melt pressures are supplied. In this case, the high control forces cause the valve pin to move to a fully open position, such that the melt pressure from the molding machine is transmitted to the cavity. Since the dynamic force is not sufficient to cause the valve pin to retract, the low melt pressure is simply transmitted to the mold cavity through a fully open valve. Self regulation of the melt pressure at these air pressures would be delivered given higher melt pressures at the valve inlet, as indicated at the by the cross symbols 772.

A person of ordinary skill in the art will appreciate further features and advantages of the invention based on the above-described embodiments Accordingly, the invention is not to be limited by what has been particularly shown and described, except as indicated by the appended claims. All publications and references cited herein are expressly incorporated herein by reference in their entity.

1. A self-regulating valve, comprising:
a body having a flow channel for conveying melt between an inlet and an outlet;
a valve pin having a distal end that is adapted to communicate with the flow channel to control the melt flowing therethrough, the distal end of the valve pin being adapted to receive a proximally-directed dynamic force that is proportional to a melt pressure of the melt at the outlet of the flow channel, and the valve pin being adapted to receive a distally-directed control force that is effective to move the valve pin in response to imbalances between the control force and the dynamic force thereby regulating a melt pressure at the outlet.

2. The valve of claim 1, wherein the valve pin is coupled to an actuator that is adapted to apply the control force to the valve pin to move the valve pin in response to imbalances between the control force and the dynamic force.

3. The valve of claim 2, wherein the control force applied by the actuator is adapted to be adjusted as a function of time.

4. The valve of claim 2, wherein the control force applied by the actuator is adapted to be adjusted in response to a melt pressure sensed at a location remote to the valve pin.

5. The valve of claim 2, wherein the actuator is selected from the group consisting of a hydraulic cylinder, a pneumatic actuator, a pre-loaded spring, a solenoid, and an electric motor.

6. The valve of claim 2, wherein the actuator is coupled to a pressure regulator that is adjustable to allow adjustment of the control force applied by the actuator to the valve pin.

7. The valve of claim 1, wherein the proximally-directed dynamic force is adapted to move the valve pin toward a closed proximal position, in which melt flowing through the outlet of the flow channel is substantially prevented, and wherein the distally-directed control force is adapted to move the valve pin toward an open distal position, in which melt flowing through the outlet is allowed.

8. The valve of claim 1, wherein the valve pin includes an aperture formed therein and in communication with the inlet in the flow channel of the body, and a distal head positioned distal of the aperture and adapted to control melt pressure at the outlet.

9. The valve of claim 8, wherein the valve pin has a cylindrical shape with an outer diameter, and wherein the aperture comprises an annular groove having a diameter of about one-half the outer diameter.

10. The valve of claim 1, wherein the valve pin extends in a direction substantially transverse to the inlet of the flow channel, and wherein the valve pin is substantially coaxial with the outlet of the flow channel.

11. The valve of claim 1, wherein the valve pin extends in a direction substantially transverse to the inlet and the outlet of the flow channel.

12. The valve of claim 1, wherein the valve is part of an apparatus selected from the group consisting of a machine nozzle, an injection mold, and an extrusion die.

13. An apparatus for controlling melt pressure, comprising:
a body having an inlet and an outlet with a flow channel extending therebetween;
a control member movably coupled to the body and adapted to receive a dynamic force proportional to a melt pressure of a melt flowing through the flow channel; and
an actuator adapted to apply a control force to the control member in response to the dynamic force, wherein differentials between the control force and the dynamic force cause movement of the control member until the control force and the dynamic force equilibrate, thereby regulating the melt pressure through the flow channel in the body.

14. The apparatus of claim 13, wherein the control member is movable between an open position, in which a melt can flow through the outlet, and a closed position, in which the melt is substantially prevented from flowing through the outlet.

15. The apparatus of claim 14, wherein the control member is adapted to move toward the closed position in response to an increase in the dynamic force, and the control member is adapted to move toward the open position in response to a decrease in the dynamic force.

16. The apparatus of claim 13, wherein the control member comprises a pin member having a proximal portion that is coupled to the actuator, and a distal portion that is positioned adjacent to the outlet.

17. The apparatus of claim 16, wherein the distal portion includes a reduced diameter region disposed within the flow channel to allow a melt to flow through the flow channel in the body, and a head distally adjacent to the reduced diameter region that is configured to regulate melt pressure at the outlet of the flow channel.

18. The apparatus of claim 16, wherein the control member is adapted to decrease melt flowing through the channel when the control member is moved in a proximal direction, and it is adapted to increase melt flowing through the channel when the control member is moved in a distal direction.

19. The apparatus of claim 13, wherein the actuator is adjustable to allow adjustment of the control force applied by the actuator to the control member.

20. The apparatus of claim 13 wherein the actuator is selected from the group consisting of a hydraulic cylinder, a pneumatic actuator, a pre-loaded spring, a solenoid, and an electric motor.

21. A method for controlling melt pressure at an outlet port of an apparatus having an inlet and an outlet port, the method comprising:
positioning a portion of a self-regulating control member within a melt flow channel such that the control member receives a dynamic force proportional to a melt pressure at the outlet of the flow channel; and
applying a control force to the control member in response to deviations in the dynamic force to regulate a melt pressure at the outlet.

22. The method of claim 21, wherein the control member is movable between an open position, in which a melt can flow through the outlet of the flow channel, and a closed position, in which the melt is substantially prevented from flowing through the outlet of the flow channel.

23. The method of claim 21, wherein the apparatus is selected from the group consisting of a machine nozzle, an injection mold, and an extrusion die.

24. The method of claim 21, wherein the control force is adjusted in response to a melt pressure sensed at a location remote to the control member.
